(19) United States
(12) Patent Application Publication
(10) Pub. No.: US 2025/0282336 A1
(43) Pub. Date: Sep. 11, 2025

(54) ELECTRONIC BRAKE SYSTEM CONTROL DEVICE

(71) Applicant: HL MANDO CORPORATION, Gyeonggi-do (KR)

(72) Inventors: Kawnseek KIM, Gyeonggi-do (KR); Heechul JUNG, Gyeonggi-do (KR)

(21) Appl. No.: 18/983,217

(22) Filed: Dec. 16, 2024

(30) Foreign Application Priority Data
Mar. 8, 2024 (KR) 10-2024-0033021

(51) Int. Cl. B60T 13/74

(52) U.S. Cl. CPC B60T 13/741; B60T 13/745; B60T 2270/402; B60T 2270/413

(57) ABSTRACT

The present disclosure relates to a redundant structure of an electronic brake system control device, and the electronic brake system control device according to the present disclosure comprises two main control units (MCUs) in one package, which control a hydraulic brake control unit and an electronic parking brake control unit, and thus even when some MCUs malfunction, a brake system is controlled by the other MCU, braking performance of a vehicle can be secured, and thus driving stability of the vehicle can be ensured.

### CROSS-REFERENCE TO RELATED APPLICATION

This application claims priority to and the benefit of Korean Patent Application No. 10-2024-0033021 filed on Mar. 8, 2024, the disclosure of which is incorporated herein by reference in its entirety.

### BACKGROUND

### 1. Field

The present disclosure relates to a brake system of a vehicle, and more particularly, to a redundant structure of an electronic brake system and a control technology thereof.

### 2. Discussion of Related Art

In recent years, as the development and sales of autonomous driving vehicles or electric vehicles have been increased, brake systems also use electronic master boosters instead of hydraulic systems. As a result, integrated dynamic brake (IDB) systems in which anti-lock brake systems (ABSs) and electric stability control (ESC) systems are integrated and constructed have been developed and used. Since this IDB system may control not only a service brake for being used in normal driving but also a parking brake, the brake system may be miniaturized and lightweight, and stability has also been greatly improved even while various functions are provided.

Since many components of such an IDB system are electronic devices, an electronic control unit (ECU) for controlling the brake system has a redundant structure including a plurality of main control units (MCUs) to increase the reliability of the brake system. Thus, even when a defect occurs in any one MCU among the plurality of MCUs, at least one parking brake may be operated by another MCU that is not defective.

However, in this redundancy structure, the plurality of MCUs are mounted on a plurality of printed circuit boards (PCBs), a motor or driver controlled by each of the MCUs should also be provided separately, and thus a volume of the system increases, and costs also increase.

Research efforts have been made to overcome the problem of the redundancy structure of the brake system of the related art, and after much efforts, the present disclosure provides a redundancy control system having a simpler structure even while sufficient performance is exhibited even in the event of an MCU failure in a control structure of the brake system.

### SUMMARY

The present disclosure relates to providing a brake system control device having a redundant structure that comprises a plurality of micro control units (MCUs) so that the brake system may perform a sufficient role even when one MCU malfunctions.

The present disclosure is also directed to providing a brake system control device in which, as the plurality of MCUs are formed in one integrated electronic control unit (ECU) structure, a system may be simplified and costs may be decreased.

Meanwhile, other unspecified purposes of the present disclosure will be additionally considered within the scope that may be easily inferred from the following detailed description and the following effects.

An electronic brake system control device according to the present disclosure comprises a first brake control unit comprising a motor position sensor, a first motor driver that drives a hydraulic brake, a valve driver, a first electronic parking brake (EPB) motor driver that drives an EPB, and a first main control unit (MCU), and a second brake control unit including a second motor driver that drives the hydraulic brake, a second EPB motor driver that drives the EPB, and a second MCU, wherein the first MCU may control the first motor driver to drive the hydraulic brake, and the second MCU may control the second motor driver to drive the hydraulic brake.

The EPB may comprise a first EPB and a second EPB, the first MCU may drive both the first EPB and the second EPB through the first EPB motor driver, and the second MCU may drive both the first EPB and the second EPB through the second EPB motor driver.

When the first MCU or the second MCU malfunctions, the MCU that does not malfunction may drive both the first EPB and the second EPB through the first EPB motor driver or the second EPB motor driver to maintain 100% of EPB performance.

When the first MCU malfunctions, the second MCU may drive the first motor driver or the second motor driver to maintain some braking performance of the hydraulic brake.

When the first MCU malfunctions, the second MCU may perform only a brake boosting system (BBS) function among functions of the first MCU.

When the second MCU malfunctions, the first MCU may drive the first motor driver or the second motor driver to maintain some braking performance of the hydraulic brake.

When the second MCU malfunctions, the first MCU may perform functions of a BBS, an antilock braking system (ABS), an electronic stability control (ESC), and an electronic brake-force distribution (EBD).

The second MCU may drive both the first EPB and the second EPB through the second EPB motor driver, and the first MCU may drive only the first EPB through the first EPB motor driver.

When the second MCU malfunctions, the first MCU may drive the first EPB through the first EPB motor driver to maintain some driving performance of the EPB.

The first brake control unit and the second brake control unit may be included in one package.

An electronic brake system control device according to another embodiment of the present in disclosure comprises a first brake control unit comprising a motor position sensor, a first motor driver that drives a hydraulic brake, a valve driver, a first EPB motor driver for driving an EPB, and a first MCU, and a second brake control unit comprising a second EPB motor driver that drives the EPB, and a second MCU, wherein only the first MCU controls the first motor driver to drive the hydraulic brake.

The EPB may comprise a first EPB and a second EPB, the first MCU may drive both the first EPB and the second EPB through the first EPB motor driver, and the second MCU may drive both the first EPB and the second EPB through the second EPB motor driver.

When the first MCU or the second MCU malfunctions, the MCU that does not malfunction may drive both the first EPB and the second EPB through the first EPB motor driver or the second EPB motor driver to maintain 100% of EPB performance.

When the first MCU malfunctions, the second MCU may drive both the first EPB and the second EPB through the second EPB motor driver to maintain braking performance.

When the first MCU malfunctions, the second MCU may perform only a brake boosting system (BBS) function among functions of the first MCU.

When the first MCU malfunctions, the second MCU may drive the first motor driver to maintain some braking performance of the hydraulic brake.

When the second MCU malfunctions, the first MCU may perform functions of a BBS, an ABS, an ESC, and an EBD.

The second MCU may drive both the first EPB and the second EPB through the second EPB motor driver, and the first MCU may drive only the first EPB through the first EPB motor driver.

When the second MCU malfunctions, the first MCU may drive the first EPB through the first EPB motor driver to maintain some braking performance of the EPB.

The first brake control unit and the second brake control unit may be included in one package.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic structural diagram of an electronic brake system control device according to an embodiment of the present disclosure;

FIG. 2 is a schematic structural diagram of an electronic brake system control device according to another embodiment of the present disclosure;

FIG. 3 is a schematic structural diagram of an electronic brake system control device according to still another embodiment of the present disclosure; and

FIG. 4 is a schematic structural diagram of an electronic brake system control device according to yet another embodiment of the present disclosure.

The accompanying drawings are exemplified as reference for understanding the technical spirit of the present disclosure, and the scope of the present disclosure is not limited thereby.

### DETAILED DESCRIPTION

The purposes, means, and effects of the present disclosure will become clearer through the following detailed description related to the accompanying drawings, and accordingly, those skilled in the art to which the present disclosure pertains will be easily implement the technical spirit of the present disclosure. Further, in the description of the present disclosure, when it is determined that the detailed description of widely known technologies related to the present disclosure may make the subject matter of the present disclosure unnecessarily unclear, the detailed description will be omitted.

Terms used in the specification are intended to describe embodiments and are not intended to limit the present disclosure. In the specification, a singular form also includes a plural form unless specifically described in a phrase in some cases. In the specification, terms such as “comprise,” “be provided with,” or “have” do not exclude the presence or addition of one or more other components other than the described components.

In the specification, terms such as “or” and “at least one” may represent one of words listed together or a combination of two or more thereof. For example, “A or B” and “at least one of A and B” may include only one of A or B or may include both A and B.

In the specification, in a description following “for example,” presented information such as cited characteristics, cited variables, or cite values may not exactly coincide, and various embodiments of the present disclosure should not be limited by effects such as deformations including an allowable error, a measurement error, a limit of measurement accuracy, and other commonly known factors.

In the specification, when it is described that a first component is “connected” or “accessed” to a second component, it should be understood that the first component is directly connected or accessed to the second component or a first component may be present therebetween. On the other hand, when it is described that the first component is “directly connected to” or “directly accessed to” the second component, it should be understood that the first component is not present therebetween.

In the specification, when it is described that a first component is provided “on” or “in contact with” a second component, the first component may be in direct contact with or connected to the second component or a first component may be present therebetween. On the other hand, it should be understood that, when it is described that a first component is provided “directly on” or “in direct contact with” a second component, a first component is not present therebetween. Other expressions that describe a relationship between components, such as “between” or “directly between,” may be interpreted similarly.

In the specification, although the terms “first,” “second,” and the like may be used to describe various components, the components should not be limited by the terms. Further, the above terms should be not interpreted to limit a sequence of the components and may be used to distinguish a first component from a second component. For example, a “first component” may be referred to as a “second component”, and similarly, a “second component” may be referred to as a “first component.”

Unless otherwise defined, all the terms used herein may be used as meanings that may be commonly understood by those skilled in the art to which the present disclosure pertains. Further, terms defined in a commonly used dictionary are not interpreted ideally or excessively unless explicitly and specifically defined.

Hereinafter, embodiments of the present disclosure will be described in detail with reference to the accompanying drawings.

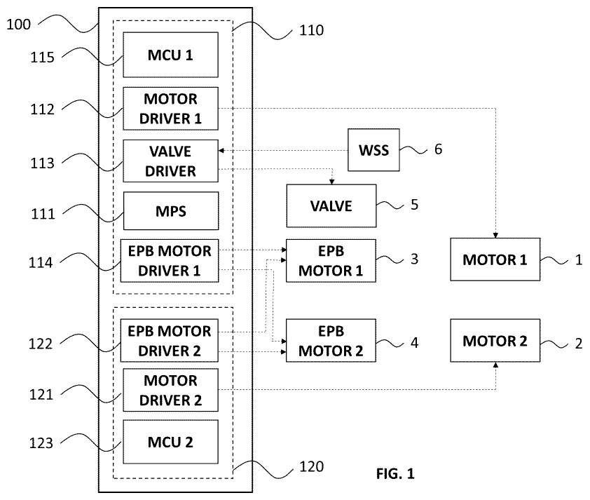

FIG. 1 is a schematic structural diagram of an electronic brake system control device according to an embodiment of the present disclosure.

An electronic brake system control device 100 according to the present disclosure may comprise a first brake control unit 110 and a second brake control unit 120.

The electronic brake system control device 100 according to the present disclosure has a structure that may comprise two or more brake control units in a redundant structure and thus perform a brake control function even when one brake control unit malfunctions. The first brake control unit 110 and the second brake control unit 120 may be included in the same package, and thus package size and manufacturing costs may be reduced.

The first brake control unit 110 may comprise a motor position sensor 111, a first motor driver 112, a valve driver 113, a first electronic parking brake (EPB) motor driver 114, and a first main control unit (MCU) 115.

The motor position sensor 111 is configured to sense a position of a first hydraulic motor 1 for driving a hydraulic brake.

The first motor driver 112 is configured to drive the first hydraulic motor 1 for driving the hydraulic brake. The first hydraulic motor 1 is configured to generate a hydraulic pressure for driving the hydraulic brake.

The first MCU 115 senses the position of the first hydraulic motor 1 using the motor position sensor 111 and controls the first motor driver 112 to drive the hydraulic brake on the basis of the detected position.

The valve driver 113 is configured to control valves for driving the hydraulic brake. To this end, the valve driver 113 may be implemented as an application specific integrated circuit (ASIC).

The first EPB motor driver 114 is configured to drive a first EPB motor 3 and a second EPB motor 4 for driving an EPB.

The first MCU 115 may control components of the first brake control unit 110 to generate a braking force of a vehicle.

The second brake control unit 120 may comprise a second motor driver 121, a second EPB motor driver 122, and a second MCU 123.

The second motor driver 121 of the second brake control unit 120 is configured to drive a second hydraulic motor 2 for driving the hydraulic brake. The second motor driver 121 drives the second hydraulic motor 2 to generate a hydraulic pressure for driving the hydraulic brake.

The second EPB motor driver 122 is configured to drive the first EPB motor 3 and the second EPB motor 4. The first EPB motor 3 and the second EPB motor 4 are configured to drive the EPB.

In the embodiment of FIG. 1, in the electronic brake system control device 100, both the first brake control unit 110 and the second brake control unit 120 drive a hydraulic brake unit to generate 100% of a braking force of the hydraulic brake. The hydraulic brake unit refers to a component for driving the hydraulic brake.

Further, both the first brake control unit 110 and the second brake control unit 120 may drive an EPB unit to generate a braking force of the EPB. The EPB unit refers to a component for driving the EPB.

In this way, when both the first MCU 115 and the second MCU 123 operate normally, 100% of the braking force of the hydraulic brake may be generated by the first MCU 115 and the second MCU 123, and the first EPB motor 3 and the second EPB motor 4 may be controlled by the first MCU 115 to generate 100% of the braking force of the EPB.

When the first MCU 115 malfunctions, the second MCU 123 may perform some functions instead of the first MCU 115.

In a normal situation, both the first MCU 115 and the second MCU 123 may generate 100% of the braking force of the hydraulic brake. Thus, even when the first MCU 115 malfunctions, the second MCU 123 may drive the second hydraulic motor 2 through the second motor driver 121. Thus, 50% of the braking force of the hydraulic brake in a normal situation in which both the first hydraulic motor 1 and the second hydraulic motor 2 normally operate may be generated.

In the case of the EPB, the second MCU 123 may control both the first EPB motor 3 and the second EPB motor 4 through the second EPB motor driver 122, and thus even when the first MCU 115 malfunctions, 100% of the braking force of the EPB may be generated by the second MCU 123.

In this case, the second MCU 123 may perform a function of a brake boosting system (BBS) among functions of the BBS, an anti-lock braking system (ABS), an electronic stability control (ESC), and an electronic brake-force distribution (EBD), which are performed by the first MCU 115.

In contrast, when the second MCU 123 malfunctions, the first MCU 115 may perform some functions instead of the second MCU 123.

In a normal situation, both the first MCU 115 and the second MCU 123 generate 100% of the braking force of the hydraulic brake. Thus, when the second MCU 123 malfunctions, the first MCU 115 may drive the first hydraulic motor 1 by the first motor driver 112, and thus 50% of the braking force of the hydraulic brake in the normal situation may be generated.

In the case of the EPB, the first MCU 115 may drive both the first EPB motor 3 and the second EPB motor 4 through the first EPB motor driver 114, and thus even when the second MCU 123 malfunctions, 100% of the braking force of the EPB may be generated by the first MCU 115.

In this case, the first MCU 115 may perform the functions of the BBS, the ABS, the ESC, and the EBD as in a normal situation.

When the first MCU 115 or the second MCU 123 malfunctions, the first hydraulic motor 1 or the second hydraulic motor 2 cannot be driven, and thus braking performance of the hydraulic brake may be assisted by the EPB. To this end, the first MCU 115 or the second MCU 123 controls the first EPB motor 3 and the second EPB motor 4 to drive the EPB.

In this case, since the EPB does not operate as a normal parking situation, the EPB operates differently from a parking situation. For example, a caliper of an EPB brake may be repeatedly tightened and loosened to generate the braking force.

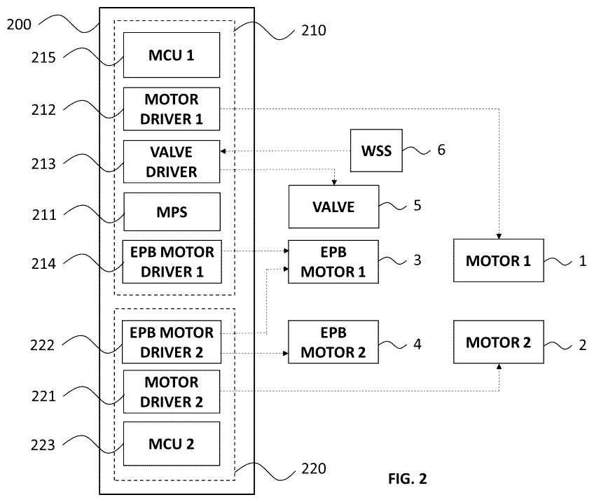

FIG. 2 is a schematic structural diagram of an electronic brake system control device according to another embodiment of the present disclosure.

An electronic brake system control device 200 according to another embodiment of the present disclosure may comprise a first brake control unit 210 and a second brake control unit 220.

The electronic brake system control device 200 according to the present disclosure has a structure that may comprise two or more brake control units in a redundant structure and thus perform a brake control function even when one brake control unit malfunctions. The first brake control unit 210 and the second brake control unit 220 may be included in the same package, and thus package size and manufacturing costs may be reduced.

The first brake control unit 210 may comprise a motor position sensor 211, a first motor driver 212, a valve driver 213, an EPB motor driver 214, and a first main control unit (MCU) 215.

The motor position sensor 211 is configured to sense a position of the first hydraulic motor 1 for driving the hydraulic brake.

The first motor driver 212 is configured to drive the first hydraulic motor 1 for driving the hydraulic brake. The first hydraulic motor 1 is configured to generate a hydraulic pressure for driving the hydraulic brake.

The valve driver 213 is configured to control valves for driving the hydraulic brake. To this end, the valve driver 213 may be implemented as an ASIC.

The first EPB motor driver 214 is configured to drive the first EPB motor 3 for driving the EPB.

The first MCU 215 may control components of the first brake control unit 210 to generate the braking force of the vehicle.

The second brake control unit 220 may comprise a second motor driver 221, a second EPB motor driver 222, and a second MCU 223.

The second motor driver 221 is configured to drive the second hydraulic motor 2 for driving the hydraulic brake. The second motor driver 221 drives the second hydraulic motor 2 to generate the hydraulic pressure for driving the hydraulic brake.

The second EPB motor driver 222 is configured to drive the first EPB motor 3 and the second EPB motor 4 for driving the EPB.

In the embodiment of FIG. 2, in the electronic brake system control device 200, both the first brake control unit 210 and the second brake control unit 220 drive a hydraulic brake unit to generate 100% of the braking force of the hydraulic brake.

In the case of the EPB, the first brake control unit 210 may drive only the first EPB motor 3, but the second brake control unit 220 may drive both the first EPB motor 3 and the second EPB motor 4 to generate the braking force of the EPB.

Thus, when both the first MCU 215 and the second MCU 223 operate normally, both the first MCU 215 and the second MCU 223 may generate 100% of the braking force of the hydraulic brake, and the first EPB motor 3 and the second EPB motor 4 may be controlled by the first MCU 215 to generate 100% of the braking force of the EPB.

When the first MCU 215 malfunctions, the second MCU 223 may perform some functions instead of the first MCU 215.

In a normal situation, both the first MCU 215 and the second MCU 223 generate 100% of the braking force of the hydraulic brake. Thus, when the first MCU 215 malfunctions, the second MCU 223 may drive the second hydraulic motor 2 through the second motor driver 221, and thus 50% of the braking force of the hydraulic brake in the normal situation may be generated.

In the case of the EPB, the second MCU 223 drives both the first EPB motor 3 and the second EPB motor 4 through the second EPB motor driver 222, and thus even when the first MCU 215 malfunctions, 100% of the braking force of the EPB may be still generated.

In this case, the second MCU 223 may perform the BBS function among the functions of the BBS, the ABS, the ESC, and the EBD performed by the first MCU 215.

In contrast, when the second MCU 223 malfunctions, the first MCU 215 may perform some functions instead of the second MCU 223.

In a normal situation, both the first MCU 215 and the second MCU 223 generate 100% of the braking force of the hydraulic brake. Thus, when the second MCU 223 malfunctions, the first MCU 215 may drive the first hydraulic motor 1 by the first motor driver 212, and thus 50% of the braking force of the hydraulic brake in the normal situation may be generated.

In the case of the EPB, the first MCU 215 may drive only the first EPB motor 3 through the first EPB motor driver 214, and thus when the second MCU 223 malfunctions, only 50% of the braking force of the EPB may be generated.

In this case, the first MCU 215 may perform the functions of the BBS, the ABS, the ESC, and the EBD as in a normal situation.

In this way, in the embodiment of FIG. 2, unlike the embodiment of FIG. 1, the first EPB motor driver 214 may drive only the first EPB motor 3, and thus when the second MCU 223 malfunctions, 50% of the braking force of the EPB may be generated.

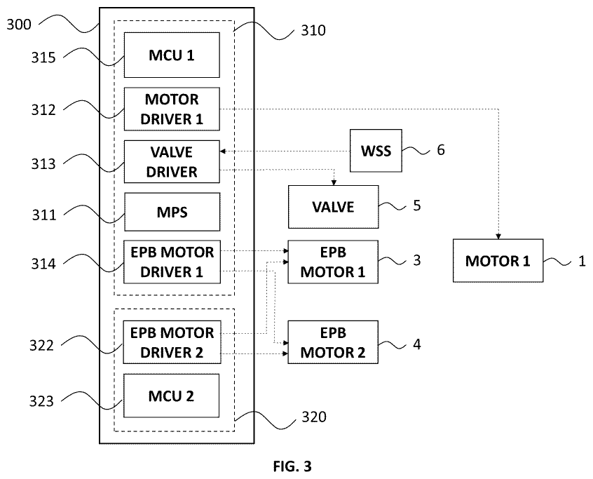

FIG. 3 is a schematic structural diagram of an electronic brake system control device according to still another embodiment of the present disclosure.

An electronic brake system control device 300 according to still another embodiment of the present disclosure may comprise a first brake control unit 310 and a second brake control unit 320.

The electronic brake system control device 300 according to the present disclosure has a structure that may comprise two or more brake control units in a redundant structure and thus perform a brake control function even when one brake control unit malfunctions. The first brake control unit 310 and the second brake control unit 320 may be included in the same package, and thus package size and manufacturing costs may be reduced.

The first brake control unit 310 may comprise a motor position sensor 311, a first motor driver 312, a valve driver 313, a first EPB motor driver 314, and a first MCU 315.

The motor position sensor 311 is configured to sense a position of the first hydraulic motor 1 for driving the hydraulic brake.

The first motor driver 312 is configured to drive the first hydraulic motor 1 for driving the hydraulic brake. The first hydraulic motor 1 is configured to generate a hydraulic pressure for driving the hydraulic brake.

The first MCU 315 senses the position of the first hydraulic motor 1 using the motor position sensor 311 and controls the first motor driver 312 to drive the hydraulic brake on the basis of the sensed position.

The valve driver 313 is configured to control valves for driving the hydraulic brake. To this end, the valve driver 313 may be implemented as an ASIC.

The first EPB motor driver 314 is configured to drive the first EPB motor 3 and the second EPB motor 4 for driving the EPB.

The first MCU 315 may control components of the first brake control unit 310 to generate the braking force of the vehicle.

The second brake control unit 320 may comprise a second EPB motor driver 322 and a second MCU 323.

Unlike the embodiments of FIGS. 1 and 2, the second brake control unit 320 does not comprise a driver for driving the hydraulic motor, and thus the driving of the hydraulic brake is controlled only by the first brake control unit 310.

The second EPB motor driver 322 is configured to drive the first EPB motor 3 and the second EPB motor 4 for driving the EPB.

Thus, both the first brake control unit 310 and the second brake control unit 320 each may drive the EPB unit to generate 100% of the braking force of the EPB.

When both the first MCU 315 and the second MCU 323 operate normally, the first MCU 315 may generate 100% of the braking force of the hydraulic brake, the first EPB motor 3 and the second EPB motor 4 may be controlled by the first MCU 315, and thus 100% of the braking force of the EPB may be generated.

When the first MCU 315 malfunctions, the second MCU 323 may perform some functions instead of the first MCU 315.

In a normal situation, the first MCU 315 generates 100% of the braking force of the hydraulic brake, and thus when the first MCU 315 malfunctions, 0% of the braking force of the hydraulic brake in the normal situation may be generated. That is, the braking force of the hydraulic brake cannot be generated at all. In this case, the second MCU may drive the first motor driver to maintain some braking performance of the hydraulic brake

Since the hydraulic brake cannot be operated at all, the braking force of the EPB may be generated by a fall back configuration therefor.

In the case of the EPB, the second MCU 323 may control both the first EPB motor 3 and the second EPB motor 4 through the second EPB motor driver 322. Thus, when the first MCU 315 malfunctions, 100% of the braking force of the EPB is generated by the second MCU 323, and thus a situation in which the hydraulic brake is not operated at all is prepared for. In this case, a valve 5 is partially controlled by the second MCU 323 and configured to remove wheel pressure.

When the first MCU 315 malfunctions, the second MCU 323 may perform the function of the BBS among the functions of the BBS, the ABS, the ESC, and the EBD, which are performed by the first MCU 315.

In contrast, when the second MCU 323 malfunctions, the first MCU 315 may perform some of the functions performed by the second MCU 323.

In a normal situation, 100% of the braking force of the hydraulic brake is alone generated by the control of the first MCU 315, and thus even when the second MCU 323 malfunctions, the first MCU 315 may control the first motor driver 312 to drive the first hydraulic motor 1 so as to generate 100% of the braking force of the hydraulic brake.

In the case of the EPB, the first MCU 315 may drive both the first EPB motor 3 and the second EPB motor 4 through the first EPB motor driver 314, and thus even when the second MCU 323 malfunctions, 100% of the braking force of the EPB may be generated by the first MCU 315.

In this case, the first MCU 315 may perform the functions of the BBS, the ABS, the ESC, and the EBD as in a normal situation.

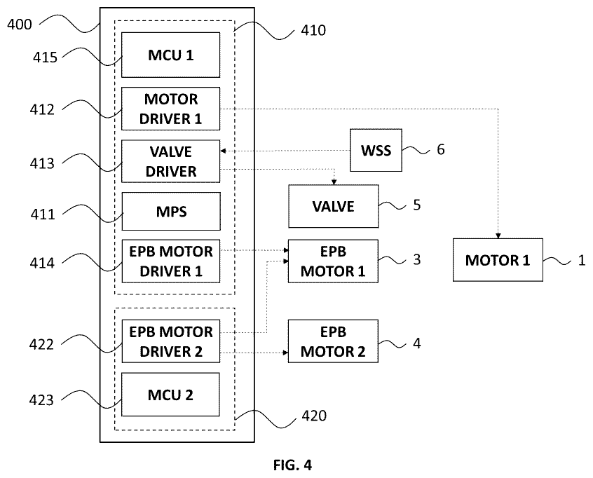

FIG. 4 is a schematic structural diagram of an electronic brake system control device according to yet another embodiment of the present disclosure.

An electronic brake system control device 400 according to yet another embodiment of the present disclosure may comprise a first brake control unit 410 and a second brake control unit 420.

The electronic brake system control device 400 according to the present disclosure has a structure that may comprise two or more brake control units in a redundant structure and thus perform a brake control function even when one brake control unit malfunctions. The first brake control unit 410 and the second brake control unit 420 may be included in the same package, and thus package size and manufacturing costs may be reduced.

The first brake control unit 410 may comprise a motor position sensor 411, a first motor driver 412, a valve driver 413, a first EPB motor driver 414, and a first MCU 415.

The motor position sensor 411 is configured to sense a position of the first hydraulic motor 1 for driving the hydraulic brake.

The first motor driver 412 is configured to drive the first hydraulic motor 1 for driving the hydraulic brake. The first hydraulic motor 1 is configured to generate a hydraulic pressure for driving the hydraulic brake.

The valve driver 413 is configured to control valves for driving the hydraulic brake. To this end, the valve driver 413 may be implemented as an ASIC.

The first EPB motor driver 414 is configured to drive the first EPB motor 3 for driving the EPB.

The first MCU 415 may control components of the first brake control unit 410 to generate the braking force of the vehicle.

The second brake control unit 420 may comprise a second EPB motor driver 422 and a second MCU 423.

Unlike the embodiments of FIGS. 1 and 2, the second brake control unit 420 does not comprise a driver for driving the hydraulic motor, and thus the driving of the hydraulic brake is controlled only by the first brake control unit 410.

The second EPB motor driver 422 is configured to drive the first EPB motor 3 and the second EPB motor 4 for driving the EPB.

Thus, since the first brake control unit 410 may drive only the first EPB motor 3, only 50% of the braking force of the EPB may be generated by the first brake control unit 410. However, the second brake control unit 420 may drive both the first EPB motor 3 and the second EPB motor 4, and thus 100% of the braking force of the EPB may be generated the second brake control unit 420.

When both the first MCU 415 and the second MCU 423 operate normally, the first MCU 415 may generate 100% of the braking force of the hydraulic brake, the first EPB motor 3 and the second EPB motor 4 may be driven by the second MCU 423, and thus 100% of the braking force of the EPB may be generated.

When the first MCU 415 malfunctions, the second MCU 423 may perform some functions instead of the first MCU 415.

Because the first MCU 415 is configured to generate 100% of the braking force of the hydraulic brake, when the first MCU 415 malfunctions, 0% of the braking force of the hydraulic brake in the normal situation may be generated. That is, the braking force of the hydraulic brake cannot be generated at all.

Thus, since the hydraulic brake cannot be operated at all, the braking force of the EPB may be generated by a fall back configuration therefor.

In the case of the EPB, the second MCU 423 is configured to drive both the first EPB motor 3 and the second EPB motor 4 through the second EPB motor driver 422, and thus when the first MCU 415 malfunctions, 100% of the braking force of the EPB is generated by the second MCU 423, and a situation in which the hydraulic brake is not operated at all is prepared for. In this case, the valve 5 is partially controlled by the second MCU 423 and configured to remove wheel pressure. As described above, in a situation in which the braking force of the hydraulic brake is 0%, the second MCU 423 may control the EPB unlike the parking situation, and thus prepare for an emergency situation.

The second MCU 423 may perform the function of the BBS among the functions of the BBS, the ABS, the ESC, and the EBD, which are performed by the first MCU 415.

In contrast, when the second MCU 423 malfunctions, the first MCU 415 may perform some of the functions performed by the second MCU 423.

In a normal situation, the first MCU 415 alone is configured to control the first motor driver 412 to generate 100% of the braking force of the hydraulic brake, and thus even when the second MCU 423 malfunctions, the first MCU 415 may still control the first motor driver 412 regardless of whether the second MCU 423 malfunctions, to drive the first hydraulic motor 1. Thus, 100% of the braking force of the hydraulic brake may be normally generated.

In the case of the EPB, the first MCU 415 may drive only the first EPB motor 3 through the first EPB motor driver 414, and thus when the second MCU 423 malfunctions, only 50% of the braking force of the EPB may be generated by the first MCU 415.

In this case, the first MCU 415 may perform the functions of the BBS, the ABS, the ESC, and the EBD as in a normal situation.

In this way, according to an electronic brake system control device according to the present disclosure, a control unit for controlling a brake system is formed in a redundant structure. Thus, even when one control unit malfunctions, some functions of the brake system are performed by other control units, and thus safety of a vehicle is increased. Further, all control units having a redundant structure are comprised in the same package, and thus a size of the control device may be decreased, and manufacturing costs may be decreased.

According to the present disclosure, as a redundancy control device for a brake system is provided, even when one MCU for controlling the brake system malfunctions, the brake system can be controlled by the other MCU.

Further, as two MCUs are included in one ECU package, a package size can decrease, and manufacturing costs can decrease.

Meanwhile, even in the case of effects not explicitly described herein, effects expected by the technical features of the present disclosure and the above description in the specification and potential effects thereof are treated as those described in the specification of the present disclosure.

Specific embodiments have been described in the detailed description of the present disclosure, but it is obvious that various modifications may be made without departing from the scope of the present disclosure. Therefore, the scope of the present disclosure is not limited to the described embodiments and should be determined by the appended claims and equivalents to the appended claims.

What is claimed is:

1. An electronic brake system control device, the device comprising:
a first brake controller comprising a motor position sensor, a first motor driver configured to drive a hydraulic brake, a valve driver, a first electronic parking brake (EPB) motor driver configured to drive an EPB, and a first main control unit (MCU); and
a second brake controller comprising a second motor driver configured to drive the hydraulic brake, a second EPB motor driver configured to drive the EPB, and a second MCU,
wherein the first MCU is configured to control the first motor driver to drive the hydraulic brake, and
the second MCU is configured to control the second motor driver to drive the hydraulic brake.

2. The device of claim 1, wherein the EPB comprises a first EPB and a second EPB,
the first MCU is configured to drive the first EPB and the second EPB through the first EPB motor driver, and
the second MCU is configured to drive the first EPB and the second EPB through the second EPB motor driver.

3. The device of claim 2, wherein, when the first MCU or the second MCU malfunctions, the MCU that does not malfunction is configured to drive the first EPB and the second EPB through the first EPB motor driver or the second EPB motor driver.

4. The device of claim 1, wherein, when the first MCU malfunctions, the second MCU is configured to drive the first motor driver or the second motor driver to maintain some braking performance of the hydraulic brake.

5. The device of claim 1, wherein, when the first MCU malfunctions, the second MCU is configured to perform a brake boosting system (BBS) function.

6. The device of claim 1, wherein, when the second MCU malfunctions, the first MCU is configured to drive the first motor driver or the second motor driver to maintain some braking performance of the hydraulic brake.

7. The device of claim 1, wherein, when the second MCU malfunctions, the first MCU is configured to perform functions of the BBS, an antilock braking system (ABS), an electronic stability control (ESC), and an electronic brake-force distribution (EBD).

8. device of claim 1, wherein the EPB comprises a first EPB and a second EPB,
the second MCU is configured to drive both the first EPB and the second EPB through the second EPB motor driver, and
the first MCU is configured to drive the first EPB motor through the first EPB motor driver.

9. The device of claim 8, wherein, when the second MCU malfunctions, the first MCU is configured to drive the first EPB through the first EPB motor driver to maintain some braking performance of the EPB.

10. The device of claim 1, wherein the first brake controller and the second brake controller are included in one package.

11. An electronic brake system control device, the device comprising:
a first brake controller comprising a motor position sensor, a first motor driver configured to drive a hydraulic brake, a valve driver, a first EPB motor driver configured to drive an EPB, and a first main control unit (MCU); and
a second brake controller comprising a second EPB motor driver configured to drive the EPB, and a second MCU,
wherein the first MCU is configured to control the first motor driver to drive the hydraulic brake.

12. The device of claim 11, wherein the EPB comprises a first EPB and a second EPB,
the first MCU is configured to drive the first EPB and the second EPB through the first EPB motor driver, and
the second MCU is configured to drive the first EPB and the second EPB through the second EPB motor driver.

13. The device of claim 12, wherein, when the first MCU or the second MCU malfunctions, the MCU that does not malfunction is configured to drive the first EPB and the second EPB through the first EPB motor driver or the second EPB motor driver.

14. The device of claim 11, wherein, when the first MCU malfunctions, the second MCU is configured to drive the first EPB and the second EPB through the second EPB motor driver to maintain braking performance.

15. The device of claim 11, wherein, when the first MCU malfunctions, the second MCU is configured to perform a brake boosting system (BBS) function.

16. The device of claim 11, wherein, when the second MCU malfunctions, the first MCU is configured to drive the first motor driver to maintain some braking performance of the hydraulic brake.

17. The device of claim 11, wherein, when the second MCU malfunctions, the first MCU is configured to perform functions of the BBS, an antilock braking system (ABS), an electronic stability control (ESC), and an electronic brake-force distribution (EBD).

18. The device of claim 11, wherein the EPB comprises a first EPB and a second EPB,
the second MCU is configured to drive the first EPB and the second EPB through the second EPB motor driver, and
the second MCU is configured to drive the first EPB through the first EPB motor driver.

19. The device of claim 18, wherein, when the second MCU malfunctions, the first MCU is configured to drive the first EPB through the first EPB motor driver to maintain some braking performance of the EPB.

20. The device of claim 11, wherein the first brake controller and the second brake controller are included in one package.
